(19) United States
(12) Patent Application Publication
(10) Pub. No.: US 2001/0016252 A1
(43) Pub. Date: Aug. 23, 2001

(54) Conductive paste and ceramic electronic device using the same

(75) Inventors: Toshiki Nagamoto, Kusatsu-shi (JP); Kunihiko Hamada, Kyoto-shi (JP)

Correspondence Address: OSTROLENK FABER GERB & SOFFEN, 1180 AVENUE OF THE AMERICAS, NEW YORK, NY, 100368403

(73) Assignee: Murata Manufacturing Co., Ltd.

(21) Appl. No.: 09/777,464

(22) Filed: Feb. 6, 2001

(30) Foreign Application Priority Data
Feb. 9, 2000 (JP) 2000-031738

(51) Int. Cl. H01B 1/22; H01G 4/12

(52) U.S. Cl. 428/209; 428/472; 428/697; 428/699; 75/254

(57) ABSTRACT

A conductive paste is provided which can ensure plating adhesion and joint strength between an external electrode and a ceramic body, and which can prevent sticking between electronic devices. The conductive paste, which contains substantially no alkaline earth metal and no lead, comprises powdered silver; a powdered glass containing an alkali metal oxide, boron oxide, silicon oxide, zinc oxide, and aluminum oxide; and an organic vehicle; wherein the powdered glass is composed of about 5 to 12 percent by weight of alkali metal oxide as M₂O, M being at least one element selected from the group consisting of Li, Na, K, Rb, Cs and Fr, about 35 to 45 percent by weight of boron oxide as B₂O₃, about 10 to 20 percent by weight of silicon oxide as SiO₂, about 35 to 45 percent by weight of zinc oxide as ZnO, and about 1 to 5 percent by weight of aluminum oxide as Al₂O₃.

### BACKGROUND OF THE INVENTION

1. Field of the Invention

The present invention relates to conductive pastes and ceramic electronic devices, and more particular, relates to a conductive paste for forming external electrodes for use in laminated ceramic capacitors, and to a laminated ceramic capacitor provided with external electrodes formed by using the conductive paste.

2. Description of the Related Art

Conventional ceramic electronic devices, in particular, laminated ceramic electronic devices, are composed of a ceramic body and external electrodes formed on two edge surfaces of the ceramic body. In a ceramic electronic device having internal electrodes and a ceramic body formed by laminating a plurality of ceramic layers, each internal electrode is formed between ceramic layers so that one end of the internal electrode is exposed at one of the edge surfaces of the corresponding ceramic layer, and the external electrodes are connected to the internal electrodes via the exposed ends thereof.

When external electrodes are formed, conductive pastes are used in many cases. The conductive paste is formed of, for example, a powdered conductive material composed of Ag, Ag/Pd or the like, and a glass frit, which are dispersed in an organic vehicle composed of an organic binder and an organic solvent, and the external electrodes are formed by a step of immersing a ceramic body in the conductive paste thus formed so as to coat the conductive paste on the edge surfaces of the ceramic body, a step of drying, and a step of baking.

In addition, in order to improve solder wettability and heat resistance to soldering of the external electrodes, various electroplating, such as nickel (Ni) plating, may be performed on the surfaces of external electrodes in some cases. However, when plating is performed over long periods of time, the plating solution permeates the external electrode via pores formed therein and reaches the interface between the external electrode and the ceramic body, and as a result, a joint strength (tensile strength) of the external electrode may be decreased in some cases.

In order to prevent the problem described above, as glass frit used in a conductive paste, a zinc borosilicate glass containing a large amount of SiO₂, which has superior solubility resistance to a plating solution, is used. When this glass frit is used, the decrease in joint strength can be suppressed; however, a problem may arise in that the glass localizes on the surface of the external electrode after baking, and hence, plating cannot be performed uniformly in a subsequent plating step.

Concerning this problem, Japanese Examined Patent Application Publication No. 8-17136 discloses that when a barium zinc borosilicate glass is used, a decrease in joint strength caused by plating between an external electrode and a ceramic body can be prevented, and the plating adhesion can be ensured. In addition, Japanese Examined Patent Application Publication No. 8-34168 discloses that when a zinc borosilicate glass is used containing lead oxide and an oxide composed of an alkaline metal and an alkaline earth metal, in addition to the two advantages described in the publication above, a crystal phase is formed at the interface between the external electrode and the ceramic body, and hence, cracking in the ceramic body generated by thermal shock or the like, can be prevented.

That is, when a glass having superior wettability to a ceramic body is used, i.e., when a glass having a small contact angle to a ceramic body is used, the glass localizes at the interface between the external electrode and the ceramic body so as to decrease the amount of the glass on the surface of the external electrode, whereby the plating adhesion can be ensured, and at the same time, the joint strength of the external electrode can also be ensured.

According to Japanese Examined Patent Application Publication Nos. 8-17136 and 8-34168, the amount of the glass in the vicinity of the surface of the external electrode can be decreased after baking; however, the sintering characteristics in the vicinity of the surface of the external electrode are degraded due to the decrease in amount of the glass, and the obtained electrode film tends to be porous. Consequently, a Ni plating solution or a Sn plating solution may permeate porous parts of the electrode film and may deposit therein, and a plating film may be formed inside the electrode in some cases. Residual stress produced by this plating film is significantly large, and for example, when mechanical stress is applied to a ceramic electronic device during a mounting step therefor, the generation of cracks in the ceramic body is promoted.

In addition, a so-called “sticking defect” may occur in that ceramic electronic devices are stuck together via external electrodes during baking. Even when the amount of glass present on the surface of the external electrode is small, since the glass has good wettability to the ceramic body, a phenomenon is observed in that a plurality of ceramic electronic devices are stuck together via the glass remaining on the surface of the ceramic electronic device regardless of the amount of glass.

### SUMMARY OF THE INVENTION

In order to solve the problems described above, the present invention provides a conductive paste which can ensure plating adhesion while joint strength between an external electrode and a ceramic body is ensured, and which can prevent sticking between ceramic electronic devices in a step of baking the external electrode. In addition, the present invention provides a ceramic electronic device having the external electrodes formed by using the conductive paste described above.

To these ends, a conductive paste of the present invention, which is used for forming thick electrodes for use in a ceramic electronic device, comprises a powdered conductive material containing silver; a powdered glass containing an alkali metal oxide, boron oxide, silicon oxide, zinc oxide and aluminum oxide; and a vehicle; wherein the powdered glass is composed of about 5 to 12 percent by weight of alkali metal oxide calculated as M₂O, M being at least one element selected from the group consisting of Li, Na, K, Rb, Cs and Fr, about 35 to 45 percent by weight of boron oxide calculated as B₂O₃, about 10 to 20 percent by weight of silicon oxide calculated as SiO₂, about 35 to 45 percent by weight of zinc oxide calculated as ZnO, and about 1 to 5 percent by weight of aluminum oxide calculated as Al₂O₃, and the conductive paste contains substantially no lead.

In the conductive paste according to the present invention, the powdered glass preferably contains substantially no alkaline earth metal.

In the conductive paste according the present invention, the content of the powdered glass is preferably about 2 to 15 parts by weight with respect to 100 parts by weight of the powdered conductive material.

A ceramic electronic device of the present invention comprises a laminate formed of a plurality of ceramic layers, and a pair of external electrodes formed on edge surfaces of the laminate, wherein the electrodes are formed of the conductive paste of the present invention.

In addition, in the ceramic electronic device according to the present invention, the ceramic layer is preferably an oxide ceramic layer, and more particularly, is preferably a ceramic layer primarily composed of barium titanate.

### BRIEF DESCRIPTION OF THE DRAWING

FIG. 1 is a cross-sectional view of a ceramic electronic device according to an embodiment of the present invention.

### DESCRIPTION OF THE PREFERRED EMBODIMENTS

Since a powdered glass (hereinafter referred to as a glass frit in some cases) used for a conductive paste of the present invention does not have good wettability particularly to an oxide ceramic body composed of, for example, barium titanate, that is, since the contact angle of the powdered glass is large, diffusion of the glass in an external electrode toward the interface between the external electrode and the ceramic body is suppressed, and hence, the amount of glass remaining in the external electrode is increased. Accordingly, the glass is uniformly present in a liquid form in the external electrode even at a higher temperature, and the glass in a liquid form promotes liquid-phase sintering of the external electrode, whereby the external electrode becomes dense. In addition, many of pores present in the external electrode after baking are covered by the glass.

As an alkali metal oxide contained in the glass frit used for the conductive paste of the present invention, there may be mentioned lithium oxide, sodium oxide, potassium oxide, rubidium oxide, cesium oxide and francium oxide. The total content of these alkali metal oxides, as Li₂O, Na₂O, K₂O, Rb₂O, Cs₂O and Fr₂O, must be about 5 to 12 percent by weight of the glass frit. That is, when the content is in the range mentioned above, the glass operating temperature, the glass fluidity and the ultimate breaking value of the ceramic body can be controlled so as to be appropriate values, and the so-called “sticking defect” may not occur. On the other hand, when the content of the alkali metal oxide is less than about 5 percent by weight, the glass operating temperature is increased and the glass fluidity is decreased in the baking temperature range. In contrast, when the content exceeds about 12 percent by weight, the contact angle to the ceramic body is decreased, that is, the wettability to the ceramic body is improved, and the so-called “sticking defect” may occur easily in that ceramic electronic devices are stuck together in a step of baking the external electrodes. Furthermore, the glass reacts with the ceramic body and the ultimate breaking value of the ceramic body may easily decrease.

The content of boron oxide contained in the glass frit used for the conductive paste of the present invention must be about 35 to 45 percent by weight (as B₂O₃) of the glass frit. When the content is in the range mentioned above, vitrification can be easily performed, and the glass fluidity, the solubility of external electrode in the plating solution and the joint strength of external electrode can be controlled so as to be appropriate values. On the other hand, when the content is less than about 35 percent by weight, vitrification becomes difficult to perform, and since the glass fluidity is not appropriately controlled, the sintering of the external electrode cannot be performed well. In contrast, when the content exceeds about 45 percent by weight, the solubility in the plating solution becomes too high, and hence, the joint strength of external electrode is decreased after plating.

The content of silicon oxide contained in the glass frit of the present invention must be about 10 to 20 percent by weight (as SiO₂) of the glass frit. When the content of silicon oxide is in the range mentioned above, the solubility of external electrode in the plating solution, the softening temperature of glass and the joint strength of external electrode can be controlled so as to be appropriate values. On the other hand, when the content is less than about 10 percent by weight, the solubility in the plating solution becomes too high and the joint strength of external electrode may decrease easily after plating. In contrast, when the content exceeds about 20 percent by weight, the softening temperature of glass is increased, and hence, the sintering of the external electrode cannot be performed well, whereby a dense external electrode cannot be obtained, and the joint strength between the external electrode and the ceramic body may easily decrease.

The content of zinc oxide contained in the glass frit described above must be about 35 to 45 percent by weight (as ZnO) of the glass frit. When the content of zinc oxide is in the range mentioned above, the softening temperature of glass, the glass fluidity, and the joint strength of external electrode can be controlled so as to be appropriate values, and the so-called “sticking defect” may not occur. On the other hand, when the content is less than about 35 percent by weight, the softening temperature of glass is increased, and hence, the sintering of the external electrode cannot be performed well, whereby a dense external electrode cannot be obtained, and the joint strength between the external electrode and the ceramic body may easily decrease. In contrast, when the content exceeds about 45 percent by weight, vitrification becomes difficult to perform, and in addition, the contact angle to the ceramic body is decreased, that is, the wettability to the ceramic body is improved, whereby the so-called “sticking defect” may occur easily in that ceramic electronic devices are stuck together in a step of baking the external electrodes.

The content of aluminum oxide contained in the glass frit described above must be about 1 to 5 percent by weight (as Al₂O₃) of the glass frit. When the content of aluminum oxide is in the range mentioned above, the softening temperature of glass and the joint strength of external electrode can be controlled so as to be appropriate values. On the other hand, when the content is less than about 1 percent by weight, the glass is not melted, and hence a non-melted material is produced, whereby a uniform glass frit may not be obtain. In contrast, when the content exceeds about 5 percent by weight, the softening temperature of glass is increased, and hence, the sintering of the external electrode cannot be performed well, whereby a dense external electrode may not be obtained, and the joint strength between the external electrode and the ceramic body may easily decrease.

In the conductive paste of the present invention, the glass frit preferably contains substantially no alkaline earth metal. When an external electrode is baked composed of a conductive paste using a glass frit containing an alkaline earth metal, the glass fluidity may be degraded in some cases since the glass is crystallized when the temperature is increased. As a result, the glass component may remain excessively on the surface of the external electrode and the plating adhesion may decrease significantly.

In the conductive paste of the present invention, a lead component, which is a harmful material to the environment, must not be substantially contained in the glass frit. In particular, even though a lead borosilicate glass is an effective material as a glass frit having a low softening point, lead is a harmful material to the environment and is restricted around the world.

In the conductive paste of the present invention, the content of the glass frit is preferably about 2 to 15 parts by weight with respect to 100 parts by weight of the powdered conductive material. When the content is about 2 parts by weight or more, the joint strength between the external electrode and the ceramic body is further improved. In addition, when the content is about 15 parts by weight or less, the so-called “sticking defect” may not occur in that ceramic electronic devices are stuck together when the external electrodes are baked.

In the conductive paste of the present invention, when the content of the glass frit is in the range according to the present invention, a glass frit alone or combination of at least two types of glass frits may be used.

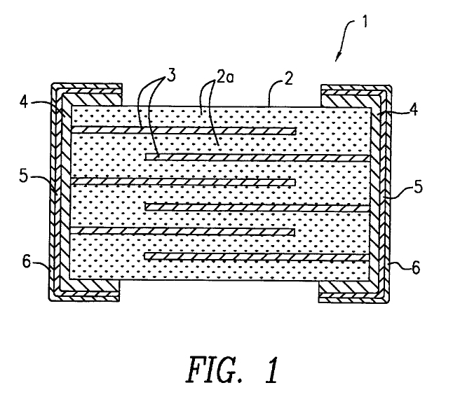

Next, as an embodiment of a ceramic electronic device of the present invention, a laminated ceramic capacitor will be described with reference to FIG. 1.

A laminated ceramic capacitor 1 is composed of a ceramic body 2 provided with a plurality of internal electrodes 3, Ni plating films 5 formed on the surface of external electrodes 4, and Sn plating films 6 formed on the Ni plating films 5. The ceramic body 2 is formed by baking a laminate composed of a plurality of oxide ceramic layers 2a primarily composed of BaTiO₃. The internal electrodes 3 are formed by baking electrode films formed on a predetermined number of ceramic layers 2a and are formed so that one end of each internal electrode 3 is exposed to one of the edge surfaces of the corresponding ceramic layer 2a. The external electrodes 4 are a pair of thick electrodes formed by baking the conductive paste of the present invention, which is coated on edge surfaces of the ceramic body 2 and is then dried, and in addition, the external electrodes 4 are formed so as to be brought into electrical and mechanical contact with the internal electrodes 3 where the internal electrodes 3 are exposed at the edge surfaces of the ceramic body 2.

In this connection, the form and the material of the ceramic body 2 of the ceramic electronic device according to the present invention, locations at which the internal electrodes 3 are formed, the number of the internal electrodes 3, connection of the internal electrodes 3 with or without the external electrodes 4, presence of the internal electrode 3 itself, materials of the plating films 5 and 6, the number of layers thereof, and the like are not specifically limited to the laminated ceramic capacitor of the embodiment described above.

### EXAMPLES

After starting materials such as oxides were first mixed together so as to have compositions in accordance with those shown in Table 1, the mixtures were melted at 1,000 to 1,200° C., the melted mixtures were vitrified by quenching, and the vitrified mixtures were finely pulverized after coarsely pulverization, whereby glass frits having 5 μm in average particle diameter of samples 1 to 11 were prepared.

An organic vehicle was prepared by mixing 25 percent by weight of an organic binder composed of ethyl cellulose and an alkyd resin and 75 percent by weight of an organic solvent composed of ethyl carbitol, 1-octanol and a kerosene-based solvent.

Next, 71 percent by weight of powdered Ag and 5 percent by weight of one of the glass frits of the samples 1 to 11 were added to and mixed with 24 percent by weight of the organic vehicle, and the mixture was then kneaded by a three-roll mill for dispersing, thereby yielding a conductive paste. In this manner, conductive pastes composed of the samples 1 to 11 were obtained.

In addition, ceramic layers primarily composed of BaTiO₃ were prepared, electrode films to be used as internal electrodes were printed on the surfaces of a predetermined number of the ceramic layers so that one end of each electrode film was exposed at one of edge surfaces of the corresponding ceramic layer, and these ceramic layers were then laminated and compressed so as to form a green ceramic body. A plurality of green ceramic bodies was thus formed.

Next, each of the conductive pastes composed of the samples 1 to 11 was coated on the two edge surfaces of the green ceramic body by immersion, and the coated green ceramic body was dried at 150° C. for 10 minutes. Subsequently, baking was performed in which the maximum temperature of 750° C. was maintained for 10 minutes in the air, whereby a pair of external electrodes was formed so as to be brought into electrical and mechanical contact with the internal electrodes. In addition, Ni plating films were formed on the pair of external electrodes by electroplating, and further, Sn plating films were formed on the Ni plating films by electroplating, thereby yielding a laminated ceramic capacitor. In this manner, laminated ceramic capacitors formed of the conductive pastes of the samples 1 to 11 were obtained.

For the laminated ceramic capacitors composed of the samples 1 to 11 formed as described above, the joint strength between the Ni plating film and the external electrode, the bending strength, and the adhesive strength between devices, i.e., the strength relating to a so-called “sticking defect”, were measured, and the results are shown in Table 1. In “Evaluation” shown in Table 1, “◯” indicates a sample having a good combination of the joint strength of external electrode, bending strength of laminated ceramic capacitor, and adhesive strength between devices.

The plating thickness is an average value obtained from five test pieces of each sample measured by a film thickness meter using x-ray fluorescence, and a thicker plating film indicates better plating adhesion. However, when a Ni plating film is excessively thick, the bending strength may be decreased. The joint strength and the bending strength are average strengths each obtained from 10 test pieces of each sample, and a higher value indicates a superior strength. The bending strength was determined by measuring the bending amount of the substrate when a sound of cracking is detected, and the measurement therefor was performed by steps of soldering each laminated ceramic capacitor formed of the samples 1 to 11 to a mount land located at a central portion of a glass-reinforced epoxy substrate, pressing the center of the substrate by using a pressing bar so as to bend the substrate, and detecting a sound of cracking by an acoustic emission (AE) sensor. For the measurement of the adhesive strength between devices, i.e., strength relating to a so-called “sticking defect”, baking was performed while an electrode film to be formed into an external electrode of one ceramic electronic device was in contact with another ceramic electronic device. The adhesive strength is an average value obtained from 10 sets of the devices, and a higher value indicates that the so-called “sticking defect” may occur more easily.

TABLE 1

| | | | | | | | | | | | | Adhesive | |
|---|---|---|---|---|---|---|---|---|---|---|---|---|---|
| | | | | | | | | | Ni | | | Strength | |
| | | | | | | | | | plating | Joint | Bending | Between | |
| | Composition of Glass Frit (wt %) | | | | | | | | thickness | Strength | Strength | Devices | |
| # | B₂O₃ | SiO₂ | ZnO | Al₂O₃ | Na₂O | Li₂O | K₂O | CaO | μm) | (N) | (mm) | (N) | Evaluation |
| 1 | 35 | 15 | 40 | 3 | 3 | 2 | 2 | 0 | 1.25 | 39.5 | 5.65 | 7.5 | 0 |
| 2 | 41 | 13 | 35 | 2 | 4 | 3 | 2 | 0 | 1.30 | 34.7 | 5.34 | 8.0 | 0 |
| 3 | 35 | 17 | 38 | 2 | 2 | 3 | 3 | 0 | 1.21 | 37.0 | 6.09 | 7.1 | 0 |
| 4 | 36 | 11 | 43 | 4 | 4 | 2 | 2 | 0 | 1.33 | 41.3 | 5.92 | 8.5 | 0 |
| 5 | 37 | 18 | 36 | 2 | 2 | 3 | 2 | 0 | 1.21 | 35.6 | 5.51 | 7.0 | 0 |
| 6 | 46 | 7 | 36 | 3 | 4 | 2 | 2 | 0 | 1.49 | 8.8 | 1.86 | 15.8 | x |
| 7 | 35 | 24 | 31 | 4 | 3 | 2 | 1 | 0 | 1.10 | 20.9 | 6.03 | 4.3 | x |
| 8 | 32 | 12 | 46 | 3 | 3 | 2 | 2 | 0 | 1.05 | 38.5 | 6.31 | 13.2 | x |
| 9 | 37 | 13 | 37 | 6 | 3 | 2 | 2 | 0 | 1.33 | 16.7 | 2.51 | 5.1 | x |
| 10 | 33 | 14 | 37 | 3 | 5 | 5 | 3 | 0 | 1.20 | 40.0 | 5.88 | 17.3 | x |
| 11 | 35 | 13 | 35 | 2 | 3 | 2 | 1 | 9 | 0.51 | 16.1 | 2.13 | 16.6 | x |

Note:
# indicates sample number

As can be seen from Table 1, the laminated ceramic capacitors formed of the glass frits of the samples 1 to 5, had Ni plating films having appropriate thicknesses of 1.21 to 1.33 μm, superior bending strengths of 5.51 to 6.09 mm and superior joint strengths of external electrode of 34.7 to 41.3 N. In addition, the adhesive strengths between devices were decreased to 7.0 to 8.5 N, and no laminated ceramic device had an adhesive strength between devices larger than the joint strength of external electrode.

In contrast, the laminated ceramic capacitor formed of the glass frit of the sample 6 containing 46 percent by weight of B₂O₃, had a Ni plating film having an excessive thickness of 1.49 μm, a very low bending strength of 1.86 mm and a low joint strength of external electrode of 8.8 N. In addition, the adhesive strength between devices was 15.8 N and exceeded the joint strength of external electrode.

The laminated ceramic capacitor formed of the glass frit of the sample 7 containing 24 percent by weight of SiO₂, had a high bending strength and a low adhesive strength between devices, but the joint strength of external electrode was decreased to 20.9 N.

The laminated ceramic capacitor formed of the glass frit of the sample 8 containing 46 percent by weight of ZnO, had a high joint strength of external electrode and a high bending strength. However, the Ni plating film was thin having a thickness of 1.05 μm, and the adhesive strength between devices, which relates to the “sticking defect”, was 13.2 N and exceeded the joint strength of external electrode.

The laminated ceramic capacitor formed of the glass frit of the sample 9 containing 6 percent by weight of Al₂O₃, had a Ni plating film having an appropriate thickness of 1.33 μm and a superior low adhesive strength between devices. However, the joint strength of external electrode was decreased to 16.7 N, and the bending strength was also decreased to 2.51 mm.

In the laminated ceramic capacitor formed of the glass frit of the sample 10 in which the total content of Na₂O, Li₂O, and K₂O, i.e., the total content of alkali metal oxides, was 6 percent by weight of the glass frit, the Ni plating film had an appropriate thickens of 1.20 μm, and in addition, the bending strength and the joint strength of external electrode were high. However, the adhesive strength between devices was increased to 17.3 N.

In the laminated ceramic capacitor formed of the glass frit of the sample 11 containing CaO, i.e., an oxide of an alkaline earth metal, the thickness of the Ni plating film was extremely decreased to 0.51 μm, the joint strength of external electrode was decreased to 16.1 N and the bending strength was also decreased to 2.13 mm. In addition, the adhesive strength between devices was increased to 16.6 N and exceeded the joint strength of external electrode.

As has thus been described, since the external electrode formed by using the conductive paste according to the present invention has superior shielding characteristics against a plating solution, the decrease in joint strength between the external electrode and the ceramic body after electroplating can be prevented, whereby a satisfactory joint strength can be obtained.

Since the glass component, which is still present on the surface of the external electrode after baking, has solubility to some extent in a Ni plating solution having weak acidity, the glass component present on the surface of the external electrode is dissolved in the plating solution, and the conductive material contained in the external electrode is exposed on the surface thereof, whereby superior plating adhesion can be obtained.

In addition, since the external electrode is dense after baking, and pores in the vicinity of the surface of the external electrode are filled with the glass, the film formation by the Ni plating solution inside the external electrode, i.e., the deposition of the Ni plating solution, can be suppressed, and as the result, the level at which cracking is generated in the ceramic body caused by a mechanical external stress applied thereto, i.e., the bending strength, can be improved.

Furthermore, since the glass component has a large contact angle to the ceramic body, when the external electrode of a ceramic electronic device, which also has a glass component thereon, is brought into contact with another ceramic electronic device during baking, the ceramic electronic devices are not stuck together via the glass component, that is, the so-called “sticking defect” is decreased, and even if the ceramic electronic devices are stuck together, the adhesive strength therebetween is low.

What is claimed is:

1. A conductive paste for forming a thick electrode for use in a ceramic electronic device, comprising:
a powdered conductive material comprising silver;
a powdered glass; and
a vehicle;
wherein the constituents of the powdered glass are about 5 to 12 percent by weight of alkali metal oxide calculated as M₂O in which M is at least one element selected from the group consisting of Li, Na, K, Rb, Cs and Fr, about 35 to 45 percent by weight of boron oxide calculated as B₂O₃, about 10 to 20 percent by weight of silicon oxide calculated as SiO₂, about 35 to 45 percent by weight of zinc oxide calculated as ZnO, and about 1 to 5 percent by weight of aluminum oxide calculated as Al₂O₃, and
wherein the conductive paste is substantially lead free.

2. A conductive paste according to claim 2, wherein the powdered glass is substantially alkaline earth metal free.

3. A conductive paste according to claim 2, wherein the powdered glass is about 2 to 15 parts by weight with respect to 100 parts by weight of the powdered conductive material.

4. A conductive paste according to claim 3, wherein the constituents of the powdered glass are about 7 to 12 percent by weight of alkali metal oxide calculated as M₂O in which M is at least one element selected from the group consisting of Li, Na and K, about 35 to 41 percent by weight of boron oxide calculated as B₂O₃, about 11 to 18 percent by weight of silicon oxide calculated as SiO₂, about 35 to 43 percent by weight of zinc oxide calculated as ZnO, and about 2 to 4 percent by weight of aluminum oxide calculated as Al₂O₃.

5. A conductive paste according to claim 4, wherein M is a combination of Li, Na and K.

6. A conductive paste according to claim 1, wherein the powdered glass is about 2 to 15 parts by weight with respect to 100 parts by weight of the powdered conductive material.

7. A conductive paste according to claim 1, wherein the constituents of the powdered glass are about 7 to 12 percent by weight of alkali metal oxide calculated as M₂O in which M is at least one element selected from the group consisting of Li, Na and K, about 35 to 41 percent by weight of boron oxide calculated as B₂O₃, about 11 to 18 percent by weight of silicon oxide calculated as SiO₂, about 35 to 43 percent by weight of zinc oxide calculated as ZnO, and about 2 to 4 percent by weight of aluminum oxide calculated as Al₂O₃.

8. A conductive paste according to claim 1, wherein M is a combination of Li, Na and K.

9. A ceramic electronic device comprising:
a laminate formed of a plurality of ceramic layers and having edge surfaces; and a pair of external electrodes on edge surfaces of the laminate;
wherein the external electrode is of a baked conductive paste according to claim 6.

10. A ceramic electronic device according to claim 9, wherein the ceramic layer is an oxide ceramic layer.

11. A ceramic electronic device according to claim 10, wherein the oxide ceramic layer comprises barium titanate.

12. A ceramic electronic device comprising:
a laminate formed of a plurality of ceramic layers and having edge surfaces; and a pair of external electrodes on edge surfaces of the laminate;
wherein the external electrode is of a baked conductive paste according to claim 4.

13. A ceramic electronic device according to claim 12, wherein the ceramic layer is an oxide ceramic layer.

14. A ceramic electronic device according to claim 13, wherein the oxide ceramic layer comprises barium titanate.

15. A ceramic electronic device comprising:
a laminate formed of a plurality of ceramic layers and having edge surfaces; and a pair of external electrodes on edge surfaces of the laminate;
wherein the external electrode is of a baked conductive paste according to claim 2.

16. A ceramic electronic device according to claim 15, wherein the ceramic layer is an oxide ceramic layer.

17. A ceramic electronic device according to claim 16, wherein the oxide ceramic layer comprises barium titanate.

18. A ceramic electronic device comprising:
a laminate formed of a plurality of ceramic layers and having edge surfaces; and a pair of external electrodes on edge surfaces of the laminate;
wherein the external electrode is of a baked conductive paste according to claim 1.

19. A ceramic electronic device according to claim 18, wherein the ceramic layer is an oxide ceramic layer.

20. A ceramic electronic device according to claim 19, wherein the oxide ceramic layer comprises barium titanate.
